(19) United States
(12) Patent Application Publication
(10) Pub. No.: US 2012/0185370 A1
(43) Pub. Date: Jul. 19, 2012

(54) SYSTEM AND METHOD FOR TRACKING REQUEST ACCOUNTABILITY IN MULTIPLE CONTENT DELIVERY NETWORK ENVIRONMENTS

(75) Inventors: Bruce S. Davie, Cambridge, MA (US); Francois Le Faucheur, Valbonne (FR)

(73) Assignee: Cisco Technology, Inc., San Jose, CA (US)

(21) Appl. No.: 13/349,777

(22) Filed: Jan. 13, 2012

Related U.S. Application Data
(60) Provisional application No. 61/432,718, filed on Jan. 14, 2011.

(51) Int. Cl. H04L 9/32; G06Q 30/04; G06F 15/16

(52) U.S. Cl. 705/34; 709/217; 713/176

(57) ABSTRACT

In one embodiment, a first content delivery network (CDN) receives a request for content from a client device, such as a web browser. The first CDN responds to the client device with a uniform resource indicator (URI) that indicates that a second (or downstream) CDN is to service the request. The URI is encoded with information identifying that the first (or upstream) CDN delegated servicing the request to the second CDN. The client device then requests the content from the second CDN using the received URI. The second CDN services the request and logs the URI in a delivery record. The second CDN may then aggregate delivery records that indicate a particular upstream CDN was the source of delegation and forward those delivery records to the particular upstream CDN for reimbursement for servicing content requests.

### RELATED APPLICATION

The present invention claims priority to U.S. Provisional Application No. 61/432,718, filed Jan. 14, 2011, entitled SYSTEM AND METHOD FOR TRACKING REQUEST ACCOUNTABILITY IN MULTIPLE CONTENT DELIVERY NETWORK ENVIRONMENTS, by Davie, et al., the contents of which are herein incorporated by reference.

### TECHNICAL FIELD

The present disclosure relates generally to computer networks, and, more particularly, to content delivery networks.

### BACKGROUND

In a content delivery network (CDN), an end user's service request for content (e.g., a web page, streaming video, etc.) is generally handled by a content router that is responsible for directing the content request towards a selected content server (e.g., cache) within the CDN. The content server is then responsible for servicing the request and, in some business models, collecting delivery records that are aggregated to allow the CDN to charge the content provider that contracted with the CDN for serving the content.

Typically, each CDN executes as a stand alone network entity in comparison to other CDNs; however, there are significant potential commercial and technical benefits that may be achieved by allowing the interconnection of CDNs. Such interconnections would permit a CDN that receives a request from an end user for specific content to elect to delegate servicing of that request to a partner CDN. CDNs as well as a model for interconnecting CDNs are generally described in Request for Comments (RFC) 3466 entitled A Model for Content Internetworking (CDI). RFC 3570 entitled Content Internetworking (CDI) Scenarios describes examples of multiple CDN environments. However, current solutions do not provide the capability to track delegation of service requests for billing purposes.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example environment with multiple content delivery networks;

FIG. 2 illustrates an example network device;

FIG. 3 illustrates an example delivery record of a log file;

FIG. 4 illustrates an example procedure for tracking request accountability in a multiple content delivery network environment; and

FIG. 5 illustrates an example procedure for aggregating request accounting information in a multiple content delivery network environment.

### DESCRIPTION OF EXAMPLE EMBODIMENTS

### Overview

According to embodiments of the disclosure, a first content delivery network (CDN) receives a request for content from a client device, such as a web browser. The first CDN responds to the client device with a uniform resource indicator (URI) that indicates that a second CDN is to service the request. The URI is encoded with information identifying that the first (or upstream) CDN has delegated servicing the request to the second (or downstream) CDN. The client device then requests the content from the second CDN using the received URI. The second CDN services the request and logs the URI in a delivery record. The second CDN may then aggregate delivery records that indicate a particular upstream CDN was the source of delegation and generate a bill for reimbursement from the particular upstream CDN. The second CDN may further delegate the servicing of the request to a third CDN. The CDN delegation path is explicitly enumerated in the URI returned to the client so that a delivery record may record the full delegation path.

### Description

A computer network is a geographically distributed collection of nodes interconnected by communication links and segments for transporting data between end nodes, such as personal computers and workstations. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

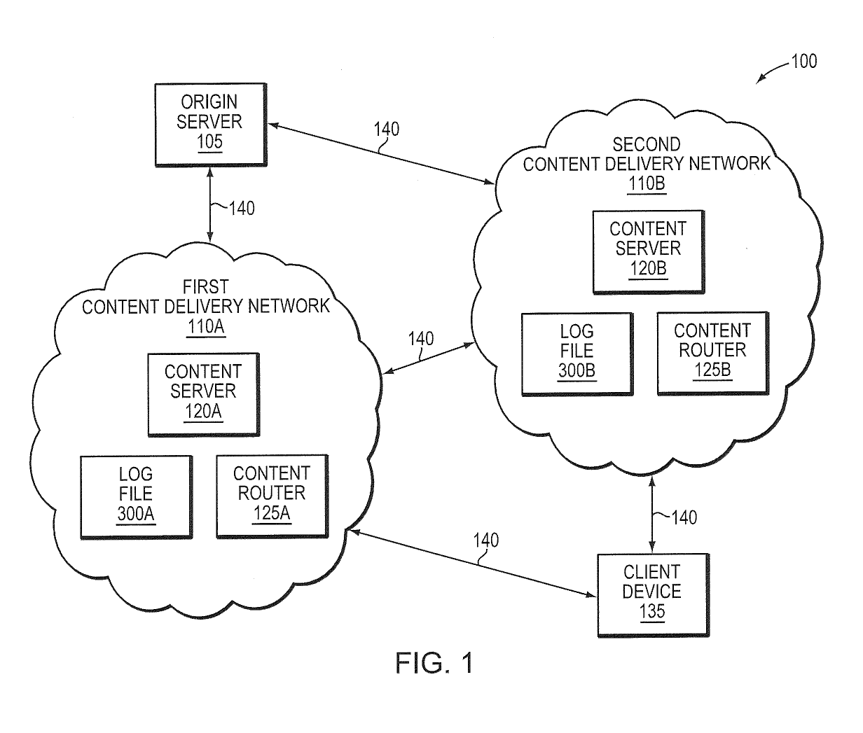

FIG. 1 is a schematic block diagram of an example multi-content delivery network environment 100 illustratively comprising nodes/devices, such as an origin server 105, a first and second content delivery network (CDN) 110A, B and a client device 135 interconnected by network links 140. The various network links 140 may comprise any form of computer network, for example Internet Protocol (IP) based networks, local-area networks (LANs), wide-area networks (WANs), etc. Further, as one skilled in the art will appreciate, each of the links 140 may comprise separate networks or may comprise a single network, such as the Internet. As such, the depiction of five separate links 140 should be taken as exemplary only.

The origin server 105 is illustratively hosted at a content provider that contracts with one or more CDNs to enable improved content delivery to end users, such as client device 135. The one or more CDNs enable content servers (caches) 120 to be geographically dispersed to enable improved access to content to various end users, such as client device 135, depending upon the geographic location of the end user. For example, the origin server 105 may be located in the United States. The first CDN may also be located within the United States, while the second CDN is located in Europe. If the client device 135 seeking content from the origin server is located within Europe, the second CDN may provide the client device with improved content delivery as compared to the first CDN due to the shorter distances involved in the transport of data.

In the example of FIG. 1, two CDNs 110A, B are shown for simplicity. In other example embodiments, any number of CDNs may be utilized to generate delegation chains in order to service a particular request. For example, a first CDN may delegate servicing a request to a second CDN which, in turn, delegates to a third CDN, etc. As such, the example of two CDNs should be taken as exemplary only.

The first and second CDNs 110 utilize devices, such as one or more content servers 120, to service content requests from client device 135. The content server 120 is a computerized device within the CDN 110 designed to provide relatively fast delivery of content to client device 135 in response to the client device, e.g., a browser of a client device, that requests content. For example, the content server 120 may be configured to cache content, e.g., a web page, from the origin server 105 to provide the content to a client device 135 in response to receiving a request for the content from the client device 135. As will be appreciated by one skilled in the art, types of content may vary and may include, e.g., web pages, documents, streaming data such as video and/or audio, etc.

The content router 125 is a computerized device configured to redirect content requests from a client device 135 to a content server 120 within the CDN. In one embodiment, each CDN may comprise a plurality of content servers 120. The content router may be configured with information regarding the location or placement of content on the various content servers within the CDN, the relative loading of each of the content servers within the CDN and the proximity of content servers to the client devices making requests. In operation, the content router 125 receives a request from client device 135 and redirects the requesting client device 135 to a content server 120 within the CDN.

The client device 135 is a computerized device such as a laptop or personal computer configured request content from the origin server. For example, a client device may be configured with a browser used to request a web page from the origin server. In general, a client device is any computerized device that issues requests for content from an origin server or CDN.

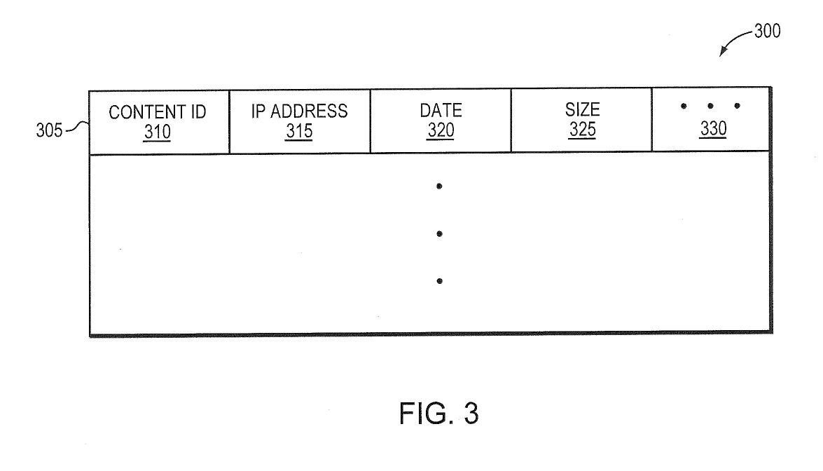

Log files 300A, B are generated by the CDNs to be utilized by their respective CDNs 110A, B for storing delivery records 305, described below in reference to FIG. 3, for multiple use including in tracking cost accountability for reimbursement purposes. Delivery records from log files 300 may be aggregated and forwarded from a downstream CDN to an upstream CDN for reimbursement. Similarly, an upstream CDN may utilize the aggregated delivery records to present to a content provider to be reimbursed.

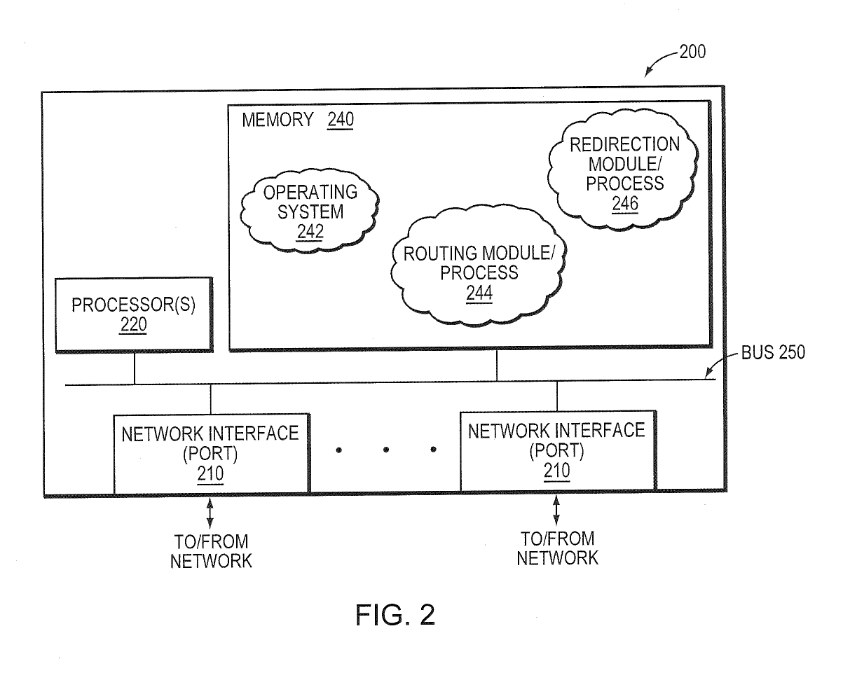

FIG. 2 is a schematic block diagram of an example node/device 200 that may be used with one or more embodiments described herein, e.g., as content router 125. The device comprises a plurality of network interfaces 210, one or more processors 220, and a memory 240 interconnected by a system bus 250. The network interfaces 210 contain the mechanical, electrical, and signaling circuitry for communicating data over physical links coupled to the network 100. The network interfaces may be configured to transmit and/or receive data using a variety of different communication protocols, including, inter alia, TCP/IP, UDP, ATM, synchronous optical networks (SONET), wireless protocols, Frame Relay, Ethernet, Fiber Distributed Data Interface (FDDI), etc. Notably, a physical network interface 210 may also be used to implement one or more virtual network interfaces, such as for Virtual Private Network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate data structures. An operating system 242 (e.g., the Internetworking Operating System, or IOS™, of Cisco Systems, Inc.), portions of which are typically resident in memory 240 and executed by the processor(s), functionally organizes the node by, inter alia, invoking network operations in support of software processes and/or services executing on the device. These software processes and/or services may comprise a routing module/process 244 and a redirection module/process 246. It will be apparent to those skilled in the art that other types of processors and memory, including various computer-readable media, may be used to store and execute program instructions pertaining to the techniques described herein.

In the example of a content router, the routing module 244 may contain computer executable instructions executed by processor 220 to perform functions provided by one or more routing protocols as will be understood by those skilled in the art. These functions may be configured to manage a forwarding information database (not shown) containing, e.g., data used to make forwarding decisions.

The redirection module 246 may contain computer executable instructions executable by the processor 220 for making redirection determinations. Such determinations may be made as to whether a particular request is to be serviced by the CDN receiving the request or whether the request should be delegated to another CDN.

FIG. 3 is an example log file data structure 300. Log file 300 comprises a plurality of delivery record entries 305. Each delivery record entry 305 comprises a content ID field 310, and network address field 315, a date field 320, a size field 325, and in alternative embodiments, additional fields 330. The log files 300 are utilized by CDNs for storing records of the content serviced by a particular CDN. By storing the information encoded in the URI as identifying the CDN that delegated a particular request, the entries 305 of the log files 300 may be utilized to track accounting information to enable downstream CDNs to be reimbursed by upstream CDNs for servicing content requests. This enables multi-CDN environments to operate in a manner in which each CDN may be reimbursed in accordance with contractual terms from CDNs that delegate servicing of requests to a particular CDN.

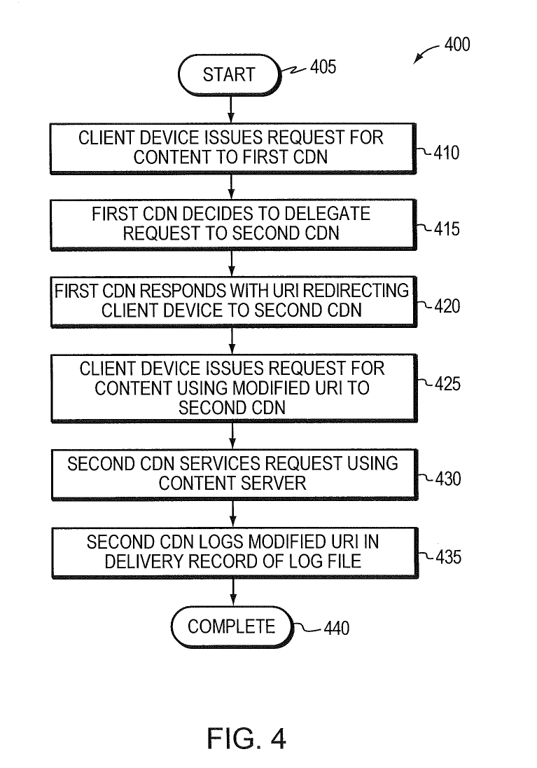

FIG. 4 is an example procedure 400 for tracking request accountability in a multi-content delivery network environment. The procedure 400 begins in step 405 and continues to step 410 where a client device issues a request for content to the first CDN. This request may comprise, e.g., a Hypertext Transport Protocol (HTTP) GET command directed to particular content identified by a uniform resource indicator (URI)/uniform resource locator (URL). The first CDN then decides, in step 415, to delegate servicing the request to the second CDN. This decision may be made due to the geographic location of the second CDN and/or the requesting client device. For example, if the first CDN is located in the United States, while the second CDN and the client device are both located in Europe, improved content delivery is possible by delegating servicing of the content requested to the second CDN.

In response to this determination, the first CDN responds to the client device's request with a URI redirecting the client device to the second CDN in step 420. The URI that is returned to the client device comprises information identifying the CDN that is delegating the servicing of the request. In this way, the URI is modified to contain the necessary information to charge a delegating CDN for costs associated with servicing a request by a downstream CDN. By encoding the CDN delegation chain within the URI, the URI becomes self-describing as to the chain of referring CDN(s) for a particular request. In one example, the response includes the URI in the response in a Location response header of a HTTP response to the request for content.

In one embodiment, the chain of CDN delegation is encoded inside the query string portion of the URI. For example, each CDN in the delegating path may be identified by a registered Internet domain name (or subdomain). In such an exemplary embodiment, the client device may receive an HTTP redirection with the URI in the form of: http://cache.downstream_cdn.com/path/Object-ID?CDN_Path=upstream_cdn.com.

The domain name cache.downstream_cdn.com represents a domain associated with the downstream (second) CDN to which the request is being delegated. The CDN_Path query tag identifies that the value is the domain name (i.e., upstream_cdn.com) of the CDN that has delegated the request.

In another embodiment, the CDN delegation chain is encoded in the absolute path portion of the URI. In such an embodiment, the client device may receive a redirection URI of the form: http://cache.downstream_cdn.com/_cdn_path_/upstream_cdn.com/_cdn_path_/Object-ID.

To provide security, including non-repudiation and protection against spoofing attacks, the upstream CDN may cryptographically sign at least the CDN path portion of the URI. In one exemplary embodiment, the upstream CDN utilizes its private key (of a public-private key pair) to cryptographically sign at least the CDN path portion of the URI. The downstream CDN then utilizes the upstream CDN's public key to verify that the URI was signed by the upstream CDN. It should be noted that the use of a public-private key system is exemplary only. As will be appreciated by one skilled in the art, private (symmetric) cryptographic key techniques may be similarly utilized to verify the CDN path. In one embodiment, the signature may comprise a cryptographic hash, e.g., MD5 of at least the CDN path portion of the URI. In this example, the hash value may be appended to the returned URI. In one example, the hash value may be encoded within the query string portion of the returned URI. For example: http://cache.downstream_cdn.com/path/Object-ID?CDN_Path=upstream_cdn.com&CDN_Path_Signature=Signature Where Signature comprises the signature (e.g., hash value) of at least the CDN path portion of the URI. Further, to improve protection against non-repudiation and spoofing, the signature may also include other fields to ensure that the signature covers a single unique request. Such exemplary fields include, e.g., the network (e.g., IP) address of the client and/or a timestamp. These fields may also be encoded into the returned URI and signed by the upstream CDN. As one skilled in the art will appreciate, by making the contents that are signed as unique as possible to a given request, improved security may be obtained. It should be noted that a plurality of keys and/or signature techniques may be utilized within a single delegation chain. For example, the delegation from a first CDN to a second CDN may utilize a first key in being signed, while the delegation from the second CDN to a third CDN may utilize a second key.

In another embodiment, an upstream CDN may utilize a cookie to transmit the delegation chain. In such an embodiment, a CDN may return a cookie to the client device using the well known HTTP Set-Cookie header in its response. The client device may then forward the received cookie to the downstream CDN using the well known HTTP Cookie header when it sends its redirected request for content. The downstream CDN may store the received cookie in its log file for future billing and cost recovery purposes. Illustratively, the cookie contains the delegation path and the cryptographic information from the upstream CDN (or chain of upstream CDNs) to prevent spoofing and allow non-repudiation. Cryptographically signing the cookie allows the delegation among CDNs to be accurately and reliably established for each delegated request.

In response to receiving the URI redirecting the client device, the client device issues a second request for the content using the received URI to the second CDN. The second CDN services the received request using one of its content servers in step 430. Upon completion of servicing the request, the second CDN logs the modified URI in a delivery record entry 305 of a log file 300 in step 435. As the URI encodes the CDN delegation chain, the delivery record entry 305 includes information identifying the CDN(s) that referred the request to the servicing CDN. This information may be utilized to enable downstream CDNs to seek reimbursement from upstream CDNs. The procedure 400 then completes in step 440.

As noted above, more that two CDNs may be utilized. In such examples, the second CDN may return a further modified URI identifying a third CDN instead of servicing the content request directly. Each CDN in the delegation chain includes information about its delegation in the URI. In this way, when the content is eventually served (by the Nth CDN), delegation information for all the previous CDNs (from the first CDN to the N-1^{st} CDN) is contained in the URI. In the example of a three CDN delegation chain, the first CDN will add a first CDN path portion to the URI (and optionally sign that portion) before returning the URI to the client device. The client device will then utilize the received URI to contact the second CDN. The second CDN will return a further modified URI that identifies a third CDN and also includes the original information from the first CDN as well as information identifying the second CDN (and optionally sign the additional CDN path information). The client device may then utilize this modified URI to contact the third CDN to service its content request.

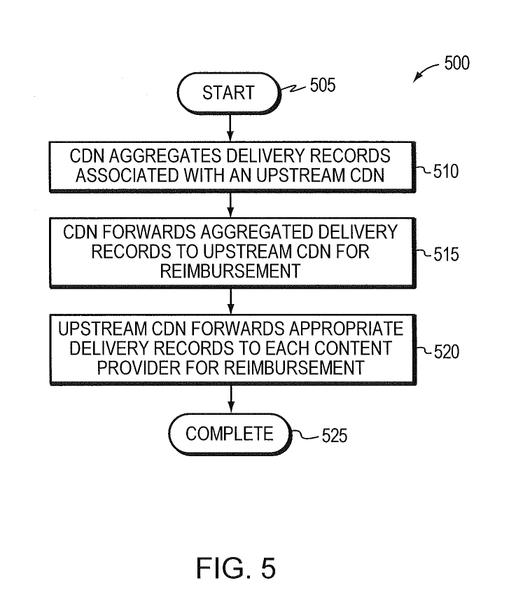

FIG. 5 is an example procedure 500 for the aggregating request accountability information. The procedure 500 begins in step 505 and continues to step 510 where a downstream CDN aggregates delivery records associated with an upstream CDN. The CDN then forwards the aggregated delivery records to the upstream CDN for reimbursement in step 515. The upstream CDN then forwards appropriate delivery records, possibly further aggregated with its own delivery records corresponding to deliveries performed by the upstream CDN itself, to each content provider for reimbursement in step 520. The procedure 500 then completes in step 525. In another example, the downstream CDN may generate a bill using the aggregated delivery records and forward the bill to the upstream CDN without requiring the forwarding of all of the delivery record.

The foregoing description has been directed to specific embodiments. It will be apparent; however, that other variations and modifications may be made to the described embodiments, with the attainment of some or all of their advantages. For instance, it is expressly contemplated that the components and/or elements described herein can be implemented as software being stored on a tangible computer-readable medium (e.g., disks/CDs/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method, comprising:
a receiving, at a first content delivery network, a request for content from a client device;
responding, by the first content delivery network to the client device, with a first uniform resource indicator indicating a second content delivery network, wherein the first uniform resource indicator includes a first delegation path from the first content delivery network to the second content delivery network and wherein the first delegation path within the uniform resource indicator is cryptographically signed; and
requesting, by the client device, the content from the second content delivery network using the first uniform resource indicator returned by the first content delivery network.

2. The method as in claim 1, further comprising:
servicing, by the second content delivery network, the request from the client device; and
logging, by the second content delivery network, the first uniform resource indicator in a delivery record.

3. The method as in claim 2, further comprising aggregating, by the second content delivery network, a plurality of delivery records and forwarding the aggregated delivery records to the first content delivery network.

4. The method of claim 2, further comprising:
generating, by the second content delivery network, a bill using the delivery record; and
forwarding the generated bill to the first content delivery network.

5. The method as in claim 1 wherein cryptographically signing the first delegation path comprises using a private key associated with the first content delivery network.

6. The method as in claim 5, wherein the second content delivery network validates the first delegation using a public key associated with the first content delivery network.

7. The method as in claim 1, wherein the first delegation path is stored in a query string portion of the first uniform resource indicator.

8. The method as in claim 1, wherein the first delegation path is stored in an absolute path portion of the first uniform resource indicator.

9. The method of claim 1, wherein the first delegation path is included in a cookie sent from the first content delivery network to the client device.

10. The method of claim 9 further comprising forwarding, by the client device, the cookie to the second content delivery network when requesting the content from the second content delivery network.

11. The method as in claim 1, further comprising:
responding, by the second content delivery network to the client device, with a second uniform resource indicator indicating a third content delivery network, wherein the second uniform resource indicator appends a second delegation path from the second content delivery network to the third content delivery network to the delegation path from the first content delivery network to the second content delivery network and wherein the second delegation path within the second uniform resource indicator is cryptographically signed.

12. The method of claim 11, wherein cryptographically signing the second delegation path utilizes a second key different from a first key used to cryptographically sign the first delegation path.

13. A system, comprising:
first content delivery network comprising a content router and a content server, the content router configured to receive a request for content and to return to a client device a first uniform resource indicator, wherein the first uniform resource indicator includes a first delegation path from the first content delivery network to a second content delivery network and wherein the first delegation path within the uniform resource indicator is cryptographically signed; and
the second content delivery network configured to receive a request for the content using the first uniform resource indicator.

14. The system of claim 13, wherein the second content deliver network is further configured to service the request for content and to log the first uniform resource indicator in a delivery record entry.

15. The system of claim 13 wherein cryptographically signed first delegation path is signed using a private key associated with the first content delivery network.

16. The system of claim 15 wherein the second content delivery network validates the first delegation path using a public key associated with the first content delivery network.

17. The system of claim 13 wherein the first delegation path is stored in a query string portion of the first uniform resource indicator.

18. The system of claim 13 wherein the first delegation path is stored in an absolute path portion of the first uniform resource indicator.

19. The system of claim 13, wherein the first delegation path is included in a cookie sent from the first content delivery network to the client device.

20. The system of claim 13, wherein the client device is further configured to forwarding the cookie to the second content delivery network when requesting the content from the second content delivery network.

21. The system of claim 13 wherein the delivery record entry is utilized for billing.

22. The system of claim 13, wherein the second content delivery network is further configured to respond to the client device with a second uniform resource indicator indicating a third content delivery network, wherein the second uniform resource indicator comprises a second delegation path from the second content delivery network to the third content delivery network appended to the delegation path from the first content delivery network to the second content delivery network and wherein the second delegation path within the second uniform resource indicator is cryptographically signed.

23. An apparatus, comprising:
means for receiving, at a first content delivery network, a request for content from a client device;
means for responding, by the first content delivery network to the client device, with a first uniform resource indicator indicating a second content delivery network, wherein the first uniform resource indicator includes a first delegation path from the first content delivery network to a second content delivery network and wherein the first delegation path within the uniform resource indicator is cryptographically signed; and
means for requesting, by the client device, the content from the second content delivery network using the first uniform resource indicator.

24. A method, comprising:
a receiving, at a first content delivery network, a request for content from a client device;
responding, by the first content delivery network to the client device, with a first uniform resource indicator indicating a second content delivery network and a cookie, wherein the cookie includes a first delegation path from the first content delivery network to the second content delivery network and wherein at least the first delegation path within the cookie is cryptographically signed; and
requesting, by the client device, the content from the second content delivery network using the first uniform resource indicator and the cookie returned by the first content delivery network.
